(19) United States
(12) Patent Application Publication
(10) Pub. No.: US 2014/0120328 A1
(43) Pub. Date: May 1, 2014

(54) DECORATION FILM

(71) Applicant: ETANSI INC., Taoyuan County (TW)

(72) Inventors: Shih-Chiang Hu, Taoyuan County (TW); Fang-Yu Su, Taoyuan County (TW)

(73) Assignee: ETANSI INC., Taoyuan County (TW)

(21) Appl. No.: 13/688,130

(22) Filed: Nov. 28, 2012

(30) Foreign Application Priority Data
Oct. 26, 2012 (TW) 101139780

(51) Int. Cl. B32B 33/00; B32B 7/02

(52) U.S. Cl. CPC B32B 33/00; B32B 7/02
USPC 428/201; 428/212

(57) ABSTRACT

A decoration film including a carrier layer, a first stacked layer and a second stacked layer is provided. The first stacked layer is disposed on the carrier layer. The second stacked layer is disposed on the carrier layer. A releasing ability of the first stacked layer releasing from the carrier layer is different from that of the second stacked layer releasing from the carrier layer so that a decoration region and a predetermined film cutting region are defined on the carrier layer by the first stacked layer and the second stacked layer respectively.

### CROSS-REFERENCE TO RELATED APPLICATION

This application claims the priority benefit of Taiwan application serial no. 101139780, filed on Oct. 26, 2012. The entirety of the above-mentioned patent application is hereby incorporated by reference herein and made a part of this specification.

### BACKGROUND

1. Technical Field

The present invention relates to a decoration film, and particularly relates to a decoration film applied to a mold forming process.

2. Description of Related Art

In the past, a pattern or a decoration formed on the plastic molded article or the metal molded article is mainly manufactured by a spraying process or a printing process to present the specific visual effect. However, due to the drawbacks of time-wasting and process complexity, the spraying process is not facilitated to mass production.

In order to solve the aforementioned problems, in-mold decoration (IMD) techniques have been provided, wherein such IMD techniques generally include In-Mold Roller (IMR), In-Mold Label (IML), Heat Transfer Printing, Sublimation Heat Transfer, Hot Stamping, Ink-Jet Printing, Water Transfer Printing, etc. All of these IMD techniques are performed by forming a decoration layer having the desired visual effect on a carrier layer (i.e., a carrier substrate) to constitute a decoration film, and then bonding the decoration layer to a molded article during the manufacturing procedure of the molded article (such as a mold ejection process of the plastic molded article or a punching process of the metal molded article) such that a decoration molded article is made.

In the IMD techniques, the carrier layer and a part of the decoration layer of the decoration film are removed to obtain the desired decoration effect. Here, if a part of the decoration layer to be removed is not removed completely, it is remained on the final article such that a quality of the finished product is not desirable, i.e., a film cutting effect is not desirable. For example, FIG. 1 is a schematic partial view of a decoration molded article having inferior film cutting effect. It can be known from the FIG. 1 that the decorated molded article 10 includes a molded article body 12 and a decoration layer 14 attached to the molded article body 12, wherein the molded article body 12 has an opening 12A. In the procedure of manufacturing the molded article 10, the decoration layer 14 is predetermined to be cut-off along an edge of the opening 12A to expose the area of the opening 12A. However, the film cutting effect of the decoration layer 14 is not desirable, which causes an additional residual portion 14A remained in the area of the opening 12A such that the quality of the decoration molded article 10 is not desirable. Here, the decorated molded article 10 needs additional work to cut the residual film 14A off for satisfying the requirement of the designer, however, the process time is postponed by such work, which is not facilitated to mass production.

### SUMMARY

The present invention is to provide a decoration film having the desirable film cutting effect.

The present invention is to provide a decoration film includes a carrier layer, a first stacked layer and a second stacked layer. The first stacked layer is disposed on the carrier layer. The second stacked layer is disposed on the carrier layer. A releasing ability of the first stacked layer releasing from the carrier layer is different from that of the second stacked layer releasing from the carrier layer so that a decoration region and a predetermined film cutting region are defined on the carrier layer by the first stacked layer and the second stacked layer respectively.

In one embodiment of the invention, a releasing layer, a protective layer, a decoration pattern layer and a first adhesion layer are stacked on the carrier layer in sequence to constitute the first stacked layer. In addition, the releasing layer, the protective layer and the decoration pattern layer are further stacked on the predetermined film cutting region of the carrier layer in sequence and a second adhesion layer is stacked on the decoration pattern layer on the predetermined film cutting region of the carrier layer to constitute the second stacked layer, wherein a glass transition temperature of the second adhesion layer is higher than a glass transition temperature of the first adhesion layer. For example, the glass transition temperature of the second adhesive ranges from 100° C. to 130° C. In another embodiment, the protective layer, the decoration pattern layer and the first adhesion layer are further stacked on the predetermined film cutting region of the carrier layer in sequence and the releasing layer is not disposed on the predetermined film cutting region of the carrier layer so as to constitute the second stacked layer. Further, the first stacked layer further includes an impact resisting layer disposed between the protective layer and the decoration pattern layer. Here, the impact resisting layer is not disposed on the predetermined film cutting region of the carrier layer. The releasing layer, the protective layer, the decoration pattern layer and the first adhesion layer are further stacked on the predetermined film cutting region of the carrier layer. A film cutting-assistant layer is further disposed on the predetermined film cutting region and stacked between the protective layer and the decoration pattern layer so as to constitute the second stacked layer. Herein, the impact resisting layer is more hard and brittle than the film cutting-assistant layer.

In one embodiment of the invention, the decoration film further includes a third stacked layer. The third stacked layer is disposed on the carrier layer to define a non-decoration region and the predetermined film cutting region is located between the decoration region and the non-decoration region. The third stacked layer is identical to one of the first stacked layer and the second stacked layer.

Based on the above, in the invention, the first stacked layer and the second stacked with different components are disposed on the carrier layer so as to define the decoration region and the predetermined film cutting region, respectively. The releasing ability of the first stacked layer releasing from the carrier layer is different from that of the second stacked layer releasing from the carrier layer so as to provide the desirable film cutting effect. Such design applied to the IMD technique is facilitated to enhance the quality of the decoration product.

In order to make the aforementioned and other objects, features and advantages of the present invention comprehensible, a preferred embodiment accompanied with is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic partial view of a decoration molded article having inferior film cutting effect.

FIG. 2 is a schematic top view of a decoration film according to an embodiment of the invention.

FIG. 3 through FIG. 10 show a plurality of embodiments illustrating the cross-sectional view of the decoration film 100 depicted in FIG. 2 along the line II-II′.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

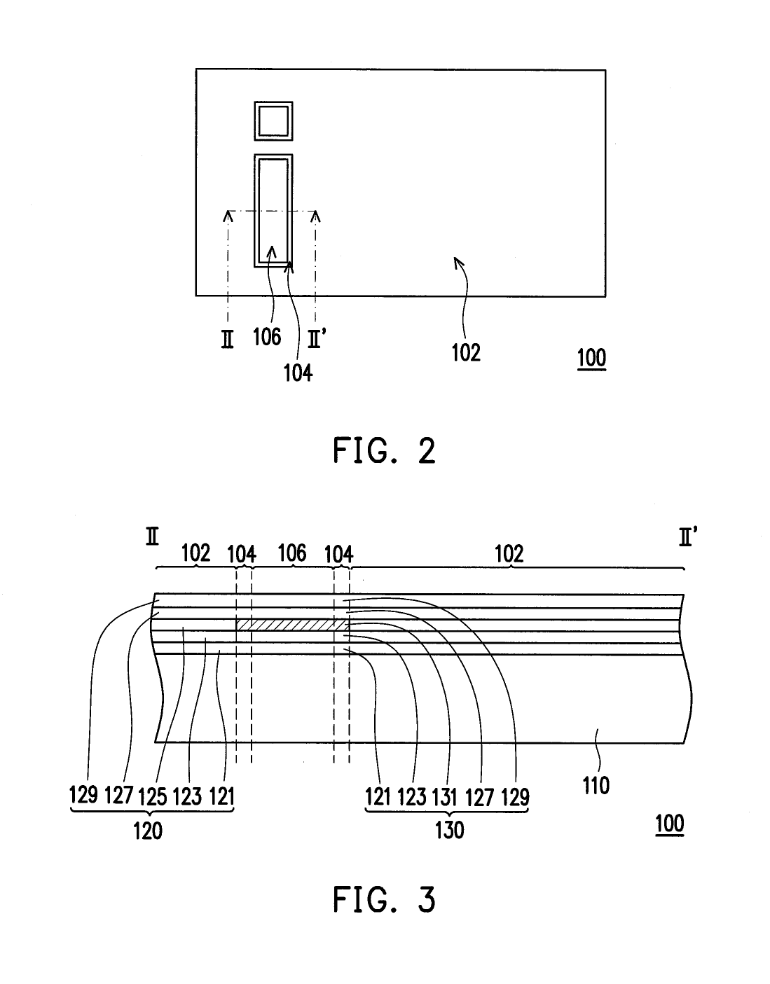

FIG. 2 is a schematic top view of a decoration film according to an embodiment of the invention. Referring to FIG. 2, a decoration film 100 has a decoration region 102, a predetermined film cutting region 104 and a non-decoration region 106, wherein the predetermined film cutting region 104 is located between the decoration region 102 and the non-decoration region 106. When the decoration film 100 is applied to the IMD techniques, the decoration region 102 is the region predetermined to be attached to the mold molded article and the non-decoration region 106 is the region predetermined not to be remained on the molded article.

It can be understood that, the predetermined film cutting region 104 is set as a region to be cut-off in the IMD procedure so that the decoration region 102 and the non-decoration region 106 are separated from each other. In general, a width of the predetermined film cutting region 104 is about 0.2 to 0.4 mm. The predetermined film cutting region 104 and the decoration region 102 preferably have different characteristics so that the decoration film 100 has desirable film cutting effect. In general, a stack of a plurality of material layers (or can be called as a stacked layer) in the decoration film 100 is used for presenting the desired decoration pattern. In this embodiment, different stacked layers are disposed on the predetermined film cutting region 104 and the decoration region 102, respectively, thereby obtaining the desired film cutting effect. A stacked layer disposed in the non-decoration region 106 can selectively be identical to one of the stacked layers disposed the predetermined film cutting region 104 and the decoration region 102. To be specific, the following descriptions accompanying with FIG. 3 through FIG. 10 illustrate the cross-section designs along the line II-II′ of the decoration film 100 in FIG. 2 according to a plurality of embodiments.

Referring to FIG. 3, the decoration film 100 can include a carrier layer 110, a first stacked layer 120 and a second stacked layer 130. The first stacked layer 120 and the second stacked layer 130 are both disposed on the carrier layer 110. The first stacked layer 120 is located on the decoration region 102 and the second stacked layer 130 is located in the decoration region 106 and the predetermined film cutting region 104, simultaneously. In other words, in this embodiment, a stacked layer disposed in the non-decoration region 106 is identical to that disposed in the predetermined film cutting region 104, however, it is only illustrated as an example and is not intended to limit the scope of the invention.

To be specific, the first stacked layer 120 includes a releasing layer 121, a protective layer 123, an impact resisting layer 125, a decoration pattern layer 127 and a adhesion layer 129 stacked outwardly from the carrier layer 110 in sequence. The second stacked layer 130 includes the releasing layer 121, the protective layer 123, a film cutting-assistant layer 131, the decoration pattern layer 127 and the adhesion layer 129 stacked outwardly from the carrier layer 110 in sequence. It means that, the releasing layer 121, the protective layer 123, the decoration pattern layer 127 and the adhesion layer 129 are formed in the decoration region 102, the predetermined film cutting region 104 and the non-decoration region 106 simultaneously. The following paragraphs first describe the material of the carrier layer 110, the releasing layer 121, the protective layer 123, the decoration pattern layer 127 and the adhesion layer 129.

The carrier layer 110 is, for example, a polymer flexible thin film capable of providing the carrying function. A material of the carrier layer 110 can be polymers such as polyethylene terephthalate (PET), polyethylene naphthalate (PEN), polyethylenc glycol-co-cyclohexane-1,4 dimethanol terephthalate (PETG), thermalplastic polyurethane (TPU), polyurethane (PU), polypropylene (PP), polycarbonate (PC), amorphous polyethylene terephthalate (A-PET), polyvinyl chloride (PVC), triacetyl cellulose (TAC), po 1 ymethylmethacrylate (PMMA), MMA-St, MS, cyclo olefin copolymer (COC), or a combination thereof.

The releasing layer 121 is usually a thin film with low surface tension which can be made of wax, paraffin, silicone, or an impermeable thin film with high smoothness and not permeable which can be made of an irradiation curable multi-functional acrylic ester, silicone acrylate, epoxy, vinyl ester, allyl vinyl compound, unsaturated polyester or a mixture thereof. A material of the releasing layer 121 can be selected from a polycondensate, a copolymer, a blend, or a mixture consisting of epoxy, polyurethane, polyimide, polyamide, hexa methoxymethyl melamine-formaldehyde, urea-formaldehyde, phenol-formaldehyde, or a combination thereof.

A material of the protective layer 123 includes radiation-cured multi-functional group acrylic ester, epoxide, vinyl ester resion, diallyo(o-)phthalate, vinyl ether or a combination thereof. The radiation-cured multi-functional group acrylic ester can be epoxy acrylate, polyurethane acrylate, polyester acrylate, silicone acrylate or glycidyl acrylate.

The decoration pattern layer 127 can be a colourful ink layer, a black ink layer, a white ink layer or a combination thereof. In one embodiment, such ink layers can be formed by any suitable printing process such as gravure printing process, screen printing process, flexographic printing process, offset printing, reverse printing process, ink jet printing process, so as to form the desired decoration pattern layer 127, and a material of the ink layers can be sublimation type transferring ink, heat-melted type transferring ink, UV-type transferring ink, and the like.

The adhesion layer 129 can be formed from polyacrylate, polymethacrylate, polystyrene, polycarbonate, polyurethane, polyester, polyamide, epoxy resin, ethylene vinylacetate copolymer (EVA) or thermoplastic elastomer or a copolymer, a blend or composite thereof.

The aforementioned material layers are formed on the carrier layer 110 completely; however, the impact resisting layer 125 and the film cutting-assistant layer 131 in this embodiment are not formed on the carrier layer 110 completely. To be specific, the impact resisting layer 125 in this embodiment is only formed on the decoration region 102 and not formed on the predetermined film cutting region 104 and the non-decoration region 106. In the mean time, the film cutting-assistant layer 131 is only formed on the predetermined film cutting region 104 and the non-decoration region 106 and not formed on the decoration region 102. As a result, a characteristic of the decoration film 100 on the predetermined film cutting region 104 is different from that on the decoration region 102. Particularly, in this embodiment, the impact resisting layer 125 is more hard and brittle compared with the film cutting-assistant layer 131 so that a releasing ability from the carrier layer 110 provided by the first stacked layer 120 is different from that provided from the second stacked layer 130 so as to achieve the desirable film cutting effect.

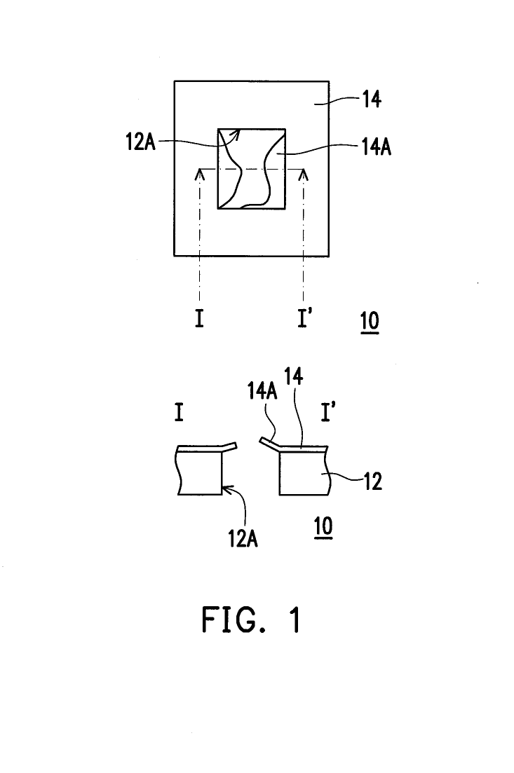

For example, a material of the impact resisting layer 125 is acrylic polyol or polymethacrylate. The disposition of the impact resisting layer 125 improves an adhesive property between the decoration pattern layer 127 and the protective layer 123 and protects the decoration pattern layer 127 by reducing the situation of ink-broken or ink-breakage. Besides, a material of the film cutting-assistant layer 131 may be selected from another acrylic polyol. Herein, the characteristic of the impact resisting layer 125 is relatively hard and brittle and the characteristic of the film cutting-assistant layer 131 is relatively soft and flexible. In the IMD procedure, the releasing ability from the carrier layer 110 provided by the first stacked layer 120 is, for example, better than that provided by the second stacked layer 130 due to the characteristic difference. Therefore, the first stacked layer 120 is prone to be separated from the carrier layer 110 and the second stacked layer 130 is not prone to be separated from the carrier layer 110, which facilitates to obtain the desirable film cutting effect. In other words, when the decoration film 100 is applied to the IMD techniques, the second stacked layer 130 and the carrier layer 110 can be removed together without remained on the final product. It means that the decoration molded article manufactured by using the decoration film 100 in this embodiment is not prone to have the residual film 14A as showed in FIG. 1.

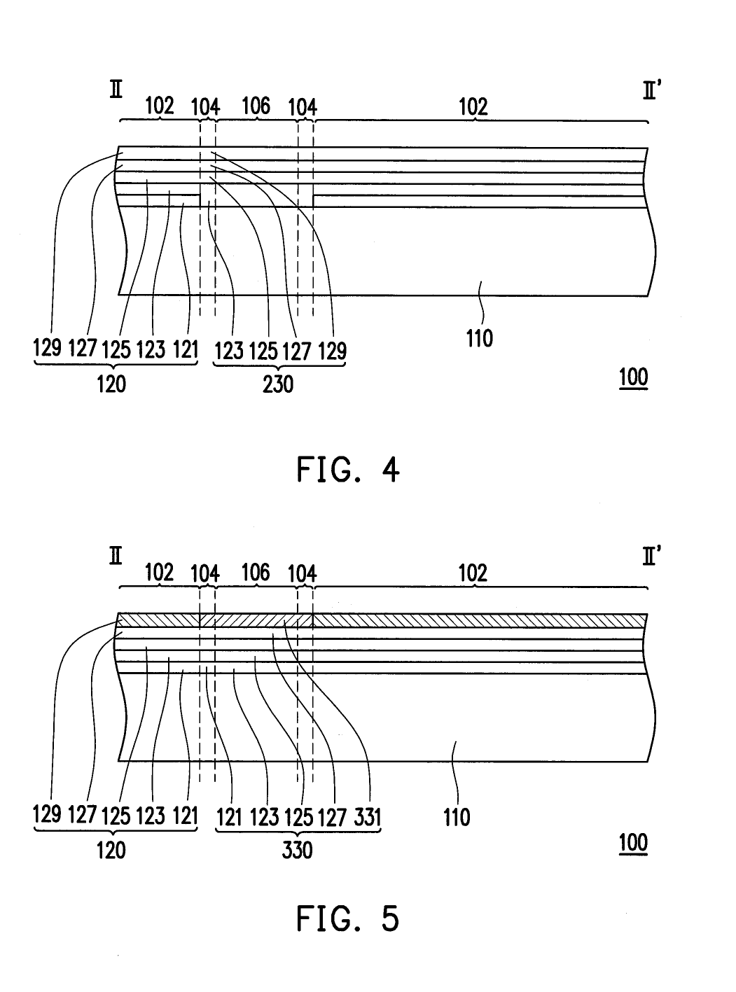

In another embodiment, referring to FIG. 4, the first stacked layer 120 is identical to that of the decoration film 100 in the embodiment illustrated in FIG. 3 and the second stacked layer 230 may include the protective layer 123, the impact resisting layer 125, the decoration pattern layer 127 and the adhesion layer 129. In other words, in this embodiment, the impact resisting layer 125 may selectively disposed on the decoration region 102, the predetermined film cutting region 104 and the non-decoration region 106 simultaneously. Meanwhile, the releasing layer 121 is selectively disposed on the decoration region 102 only and not on the predetermined film cutting region 104 and the non-decoration region 106. Here, the releasing ability provided from the first stacked layer 120 is different from that provided by the second stacked layer 230 such that the decoration film 100 has a desirable film cutting effect when the decoration film 100 is applied to the IMD techniques. In other words, in this embodiment, the desirable film cutting effect can be performed without disposing the film cutting-assistant layer 131 illustrated in FIG. 3 in the decoration film 100.

Furthermore, referring to FIG. 5, the first stacked layer 120 is identical to that of the decoration film 100 in the embodiment illustrated in FIG. 3 and the second stacked layer 330 may be composed of the releasing layer 121, the protective layer 123, the impact resisting layer 125, the decoration pattern layer 127 and another adhesion layer 331. To be specific, in this embodiment, two adhesion layers 129, 331 are used to be disposed on the decoration region 102 and on a region out of the decoration region 102 (i.e., the non-decoration region 106 and the predetermined film cutting region 104).

In this embodiment, a material of the adhesion layer 331 can be polyamino resin. Here, the glass transition temperature of the adhesion layer 331, for example, ranges from 100° C. to 150° C. or from 130° C. to 150° C., and is higher than the glass transition temperature of the adhesion layer 129. As a result, when the decoration film 100 is applied to the IMD techniques, a bonding strength between the adhesion layer 129 and the molded article is greater than that between the adhesion layer 331 and the molded article. Therefore, when the carrier layer 110 is removed from the molded article, the first stacked layer 120 is not prone to be removed together with the carrier layer 110 while the second stacked layer 330 is prone to be removed together with the carrier layer 110, comparatively. Hence, the decoration film 100 has the desirable film cutting effect in the IMD procedure. It means that, in this embodiment, a selection of the adhesive material can be made to achieve that the bonding strength between the first stacked layer 120 and the molded article is greater than that between the second stacked layer 330 and the molded article. Therefore, the first stacked layer 120 is prone to be separated from the carrier layer 110 relatively and the second stacked layer 330 is not prone to be separated from the carrier layer 110, relatively. As such, the first stacked layer 120 and the second stacked layer 330 can be easily separated from each other to perform the desired film cutting effect.

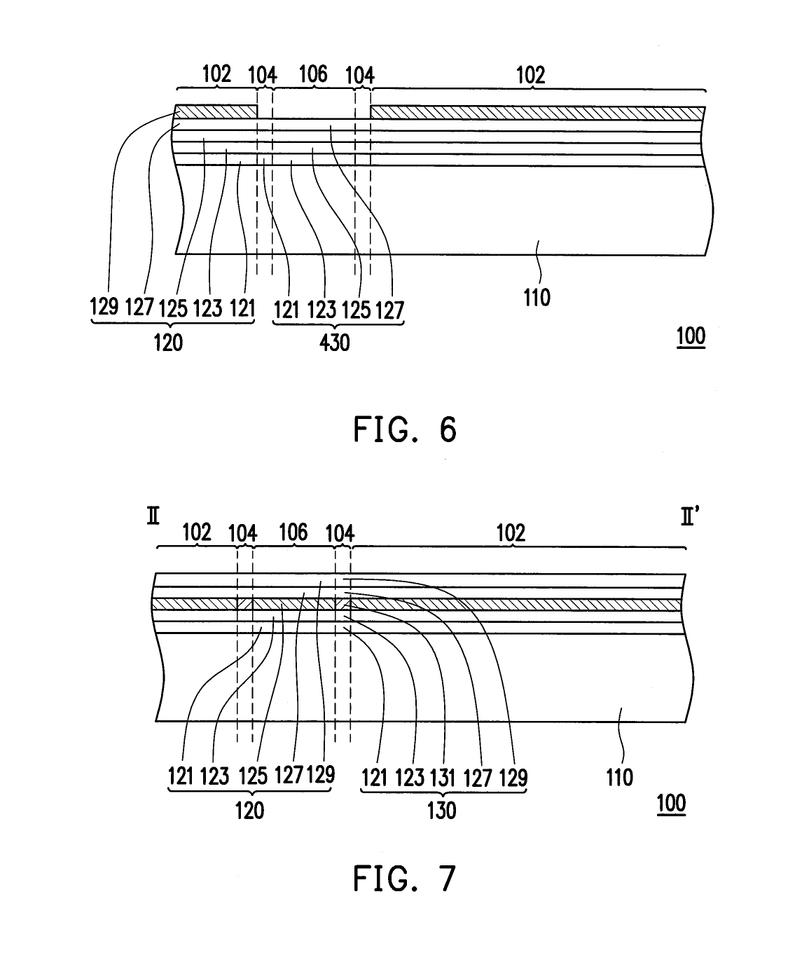

Also, as illustrated in FIG. 6, the first stacked layer 120 is identical to that of the decoration film 100 in the embodiment illustrated in FIG. 3 and the second stacked layer 430 may only include the releasing layer 121, the protective layer 123, the impact resisting layer 125 and the decoration pattern layer 127. It is that, in this embodiment, the second stacked layer 430 doesn't include the adhesion layer 129. As a result, a bonding strength between the first stacked layer 120 and the molded article is greater than a bonding strength between the second stacked layer 430 and the molded article such that the first stacked layer 120 is not prone to be removed together with the carrier layer 110 and the second stacked layer 430 is prone to be removed together with the carrier layer 110, relatively.

It is worth to note that, such embodiments illustrated in FIG. 3 through FIG. 6 indicate that the stacked layer on the non-decoration region 106 is identical to that on the predetermined film cutting region 104, however, in other embodiments, the stacked layer on the non-decoration region 106 can be identical to that on the decoration region 102.

To be specific, referring to FIG. 7, a cross-sectional structure of the decoration film 100 in this embodiment is similar to a cross-sectional structure of the decoration film 100 illustrated in FIG. 3, however, a main difference between this embodiment and the embodiment in FIG. 3 is that the second stacked layer 130 of this embodiment is only disposed on the predetermined film cutting region 104 and the stacked layer disposed on the non-decoration region 106 is identical to the first stacked layer 110. In other words, a stacked layer structure of the first stacked layer 110 is disposed on the decoration region 102 and the non-decoration region 106 simultaneously, and a stacked layer structure of the second stacked layer 130 is only disposed on the predetermined film cutting region 104. As a result, a degree of the releasing ability of the stacked layer located in the predetermined film cutting region 104 is different from that in the decoration region 102. Therefore, when the decoration film 100 is applied to the IMD techniques, a desirable film cutting effect is owned by the decoration film 100 which facilitates to enhance a quality of the final product.

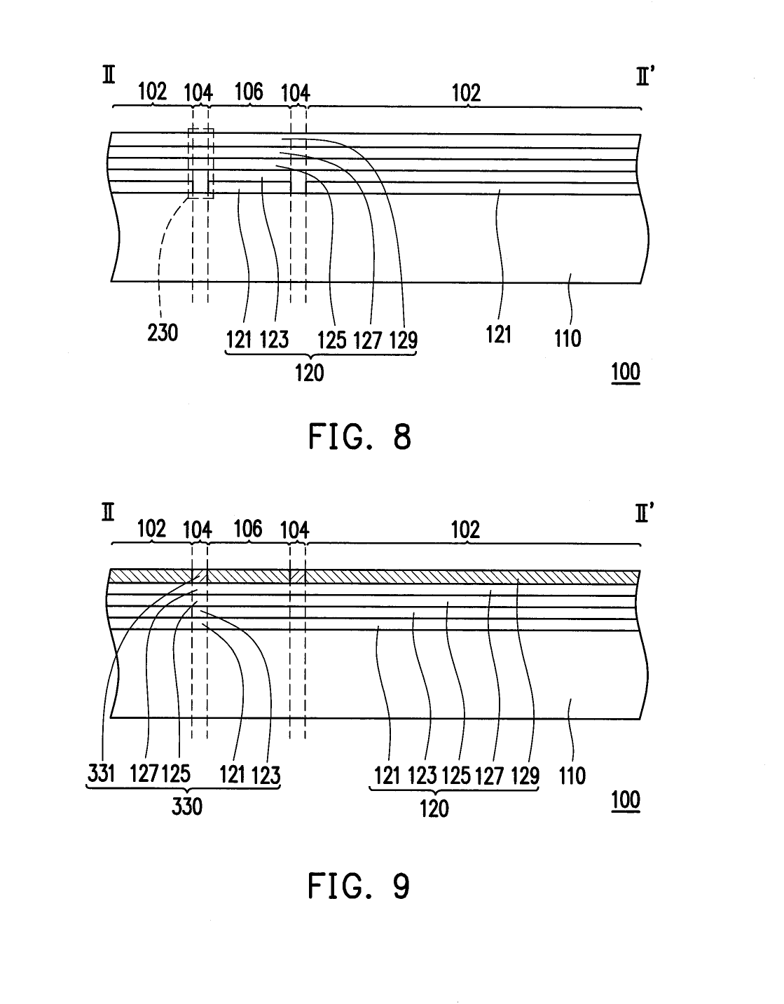

In addition, as illustrated in FIG. 8, a cross-sectional structure of the decoration film 100 in this embodiment is similar to a cross-sectional structure of the decoration film 100 illustrated in FIG. 4, wherein a main difference between this embodiment and the embodiment in FIG. 4 is that the second stacked layer 230 of this embodiment is only disposed on the predetermined film cutting region 104 and the first stacked layer 120 is further disposed on the non-decoration region 106. Such that, a stacked layer disposed on the non-decoration region 106 in this embodiment is identical to the first stacked layer 120. According to the designs of the first stacked layer 120 and the second layer 230, the releasing layer 121 is not disposed only on the predetermined film cutting region 104 in the present embodiment.

In addition, a embodiment illustrated in FIG. 9 is similar to the embodiment illustrated in FIG. 5, however, in the embodiment of FIG. 9, the adhesion layer 331 is only disposed on the predetermined film cutting region 104 and the adhesion layer 129 is disposed on the decoration region 102 and the non-decoration region 106 simultaneously. In other words, a stacked layer disposed on the non-decoration region 106 is identical to the first stacked layer 120 disposed on the decoration region 102.

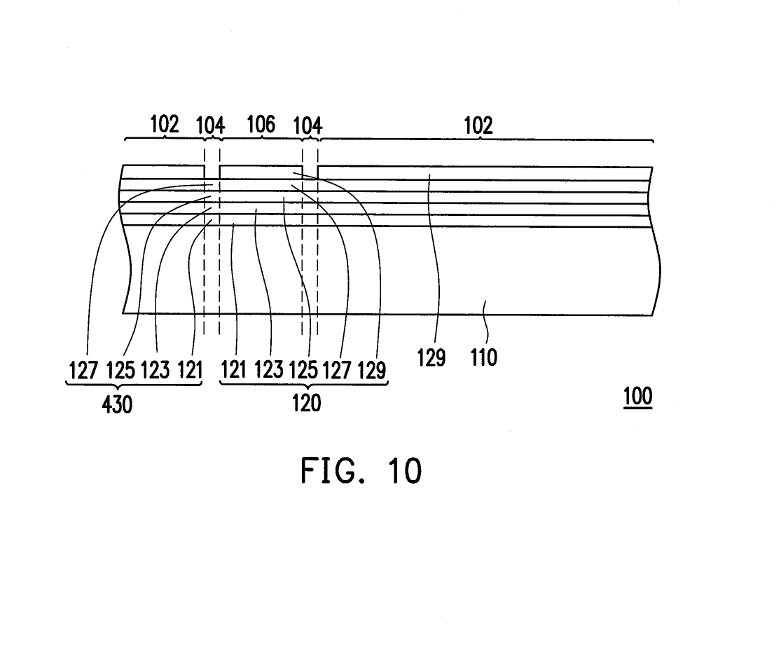

An embodiment illustrated in FIG. 10 is similar to the embodiment illustrated in FIG. 6; however, in the embodiment in FIG. 10, the adhesion layer 129 is disposed on the decoration region 102 and the non-decoration region 106 simultaneously and not disposed on the predetermined film cutting region 104. As a result, a releasing ability from the carrier layer 110 provided by the stacked layer 120 is different from that provided by the second stacked layer 430 in the IMD procedure so as to have a desirable film cutting effect.

Overall, such embodiments illustrated in FIG. 7 through FIG. 10 indicate that the stacked layer disposed on the decoration region 102 and the non-decoration region 106 have the same structure, and the stacked layer disposed on the predetermined film cutting region 104 is different from that disposed on the decoration region 102. As a result, the different releasing abilities can still be provided by the decoration film 100 on the predetermined film cutting region 104 and on the decoration region 102 so as to perform the desirable film cutting effect. In other words, in this invention, a design of the stacked layer on the decoration region 102 and a design of the stacked layer on the non-decoration region 106 are not limited to be identical or different. The film cutting effect of the decoration film 100 is enhanced as long as the stacked layer on the decoration region 102 is more hard and brittle relative to the stacked layer on the predetermined film cutting region 104, or the stacked layer on the decoration region 102 is more easy to be released from the carrier layer 110 relative to the stacked layer on the predetermined film cutting region 104.

According the above descriptions, in this invention, a releasing ability of the decoration film on the decoration region is different from a releasing ability of the decoration film on the predetermined film cutting region by stacking different material layers on the decoration region and the predetermined film cutting region. As such, when the decoration is applied to the IMD techniques, the decoration film can provide the desirable film cutting effect to enhance the quality of decorated molded article.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A decoration film, comprising:
a carrier layer;
a first stacked layer, disposed on the carrier layer; and
a second stacked layer, disposed on the carrier layer, and a releasing ability of the first stacked layer releasing from the carrier layer being different from a releasing ability of the second stacked layer releasing from the carrier layerso that a decoration region and a predetermined film cutting region adjacent to each other being defined on the carrier layer by the first stacker layer and the second stacked layer respectively.

2. The decoration film as claimed in claim 1, wherein a releasing layer, a protective layer, a decoration pattern layer and a first adhesion layer are stacked on the decoration region of the carrier layer in sequence to constitute the first stacked layer.

3. The decoration film as claimed in claim 2, wherein the releasing layer, the protective layer and the decoration pattern layer are further stacked on the predetermined film cutting region of the carrier layer in sequence and a second adhesion layer is stacked on the decoration pattern layer disposed in the predetermined film cutting region of the carrier layer to constitute the second stacked layer, and a glass transition temperature of the second adhesion layer is higher than a glass transition temperature of the first adhesion layer.

4. The decoration film as claimed in claim 3, wherein the glass transition temperature of the second adhesive ranges from 100° C. to 130° C.

5. The decoration film as claimed in claim 2, wherein the protective layer, the decoration pattern layer and the first adhesion layer are further stacked on the predetermined film cutting region of the carrier layer in sequence and the releasing layer is not disposed on the predetermined film cutting region of the carrier layer to constitute the second stacked layer.

6. The decoration film as claimed in claim 2, wherein the first stacked layer further includes an impact resisting layer disposed between the protective layer and the decoration pattern layer.

7. The decoration film as claimed in claim 6, wherein the impact resisting layer is not disposed on the predetermined film cutting region of the carrier layer, and the releasing layer, the protective layer, the decoration pattern layer and the first adhesion layer are further stacked on the predetermined film cutting region of the carrier layer, and a film cutting-assistant layer is further disposed on the predetermined film cutting region and stacked between the protective layer and the decoration pattern layer to constitute the second stacked layer.

8. The decoration film as claimed in claim 1, further comprising a third stacked layer, the third stacked layer being disposed on the carrier layer to define a non-decoration region and the predetermined film cutting region being located between the decoration region and the non-decoration region.

9. The decoration film as claimed in claim 8, wherein the third stacked layer is identical to one of the first stacked layer and the second stacked layer.
